(19) United States
(12) Patent Application Publication
(10) Pub. No.: US 2004/0015587 A1
(43) Pub. Date: Jan. 22, 2004

(54) System for transferring tools to resources

(76) Inventors: Judy J. Kogut-O'Connell, Hopewell Junction, NY (US); David P. Rueckle, Endwell, NY (US); Mary E. Stoeckel, Endicott, NY (US)

Correspondence Address: FREDERICK W. GIBB, III, MCGINN & GIBB, PLLC, 2568-A RIVA ROAD, SUITE 304, ANNAPOLIS, MD, 21401, US

(21) Appl. No.: 10/177,956

(22) Filed: Jun. 21, 2002

(51) Int. Cl. G06F 15/173; G06F 9/00

(52) U.S. Cl. 709/226

(57) ABSTRACT

A method and structure for transferring tools to resources is disclosed. The resources use the tools to accomplish tasks. The system includes a public server connected to the resources, a tool server connected to the public server, and a database connected to the public server. The database maintains information regarding a software and hardware profile of each of the resources and task capabilities of the resources. The public server assigns the tasks to the resources based upon the task capabilities of the resources. The public server provides the tools from the tool server to the resources to accomplish the tasks. The public server provides a version of the tool to the resource, based upon the software and hardware profile. The resources are provided an opportunity to verify and update the software and hardware profile and the task capabilities as each task is assigned and each tool is provided.

### BACKGROUND OF THE INVENTION

1. Field of the Invention

The present invention generally relates to a system for transferring tools to resources and more particularly to a system that utilizes a public server connected to the resources.

2. Description of the Related Art

It is common for large corporations to communicate with their suppliers through an automated or semi-automated ordering system. In such a system, when parts or services are required from the suppliers (resources), the corporation needs to know the suppliers' capabilities. The invention described below addresses this and other needs.

### SUMMARY OF THE INVENTION

In one embodiment, the invention provides a system for transferring tools to resources. The resources use the tools to accomplish tasks. The system includes a public server connected to the resources, a tool server connected to the public server, and a database connected to the public server. The database maintains information regarding a software and hardware profile of each of the resources and task capabilities of the resources. The public server assigns the tasks to the resources based upon the task capabilities of the resources. The public server provides the tools from the tool server to the resources to accomplish the tasks. The public server provides a version of the tool to the resource, based upon the software and hardware profile. The resources are provided an opportunity to verify and update the software and hardware profile and the task capabilities as each task is assigned and the tool is provided.

With the invention, development teams are able to load to a common website within the installer for their application specific needs. The invention resolves the constant need to invent separate registration methodologies for each new application needed to be launched. The invention accommodates all operating systems and eliminates specialized work conventionally needed for deployment of each new application.

### BRIEF DESCRIPTION OF THE DRAWINGS

The foregoing and other objects, aspects and advantages will be better understood from the following detailed description of preferred embodiments of the invention with reference to the drawings, in which:

FIG. 1 is a schematic diagram of one embodiment of the invention;

FIG. 2 is a flow diagram illustrating a preferred method of the invention; and

FIG. 3 is a hardware diagram of the invention.

### DETAILED DESCRIPTION OF PREFERRED EMBODIMENTS OF THE INVENTION

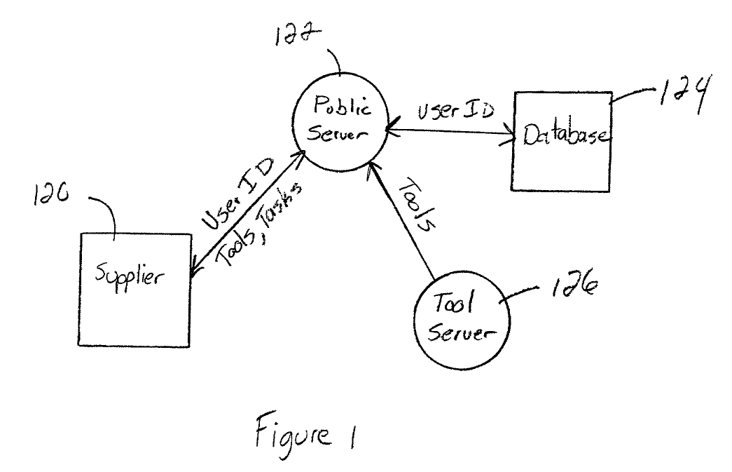

As mentioned above, the invention resolves the constant need to invent separate registration methodologies for each new application needed to be launched. With reference to FIG. 1 below, the invention is designed to assign tasks to resources 120 through a public server 122.

The public server is connected to a database 124 that maintains information on the capability of each resource (e.g., supplier) 120 to perform a specific task (e.g., report on capacity, update profile, etc.). If the public server 122 assigns a task to the resource 120, it also supplies the resources 120 with the tools (e.g., software) to accomplish the task.

The public server 122 obtains these tools from a tool server 126 (which may include multiple databases). The database 124 also maintains various hardware and software profiles of each of the resources 120. By knowing each resource's hardware and software profiles, the public server 122 can provide the correct version of the tool to the resource 120 and can also communicate with the resource 120 in its native language. Another feature of the invention is that it provides the resource 120 with a profile that the resource 120 can approve and/or change before the various tasks are assigned.

For example, it is common for large corporations 122 to communicate with their suppliers 120 through an automated or a semi-automated system. In such a system, when parts or services are required from the suppliers (resources 120), the corporation needs to know the suppliers' capabilities. The invention provides this information from the database 124. The database 124 is always kept current, using the feature of providing each supplier 120 with an opportunity to update their profile.

In addition, the corporation 122 will provide the supplier 120 with the various software tools that may be required to understand and work with the corporation's needs. For example, the corporation 122 may issue tasks such as requests to prepare licensing agreements, user guidelines, etc. Each of these tasks may require a specific tool (e.g., self-enabling documents, agreements, guidelines, etc.) Therefore, the corporation 122 also supplies the tools to the supplier 120. The suppliers 120 may have different levels of hardware/software sophistication and the tools provided to the suppliers 120 are selected so that they match the hardware/software of the suppliers 120 and so that they work with the other applications the supplier 120 may be utilizing.

Prior to the invention, the tool server 126 communicated with the supplier directly and independently of the public server and without the benefit of the information maintained within the database 124. In such prior systems, the public server 122, tool server 126, and supplier 124 were required to independently determine their own needs and independently locate the resources that could satisfy those needs (without the assistance of the database 124). The prior systems were much less effective than the invention and it was common for corporations to misunderstand suppliers' capabilities and for suppliers to be provided inappropriate tasks and/or tools. With the invention, the supplier 120 is automatically provided with everything needed to accomplish the task assigned. In addition, the corporation 122 is able to track the needs and abilities of its suppliers 120 when monitoring the progress of the various tasks assigned to the suppliers 120.

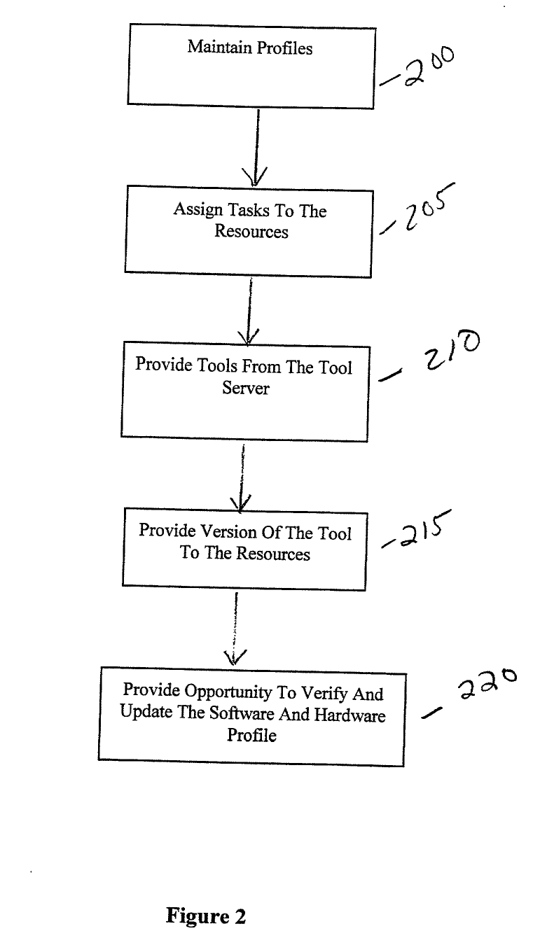

FIG. 2 is a flowchart illustrating the processing achieved with the invention. More specifically, in item 200, the invention maintains information regarding the software and hardware profiles of each of the resources and task capabilities of the resources. Then, in item 205, the invention assigns the tasks to the resources (using the public server) based upon the task capabilities of the resources. In item 210, the invention provides the tools from the tool server to the resources to accomplish the tasks (using the public server). In item 215, the invention provides a version of the tool to the resource, based upon the software and hardware profile (again, using the public server). The invention also provides an opportunity to verify and update the software and hardware profile and the task capabilities as each task is assigned and the tool is provided (item 220).

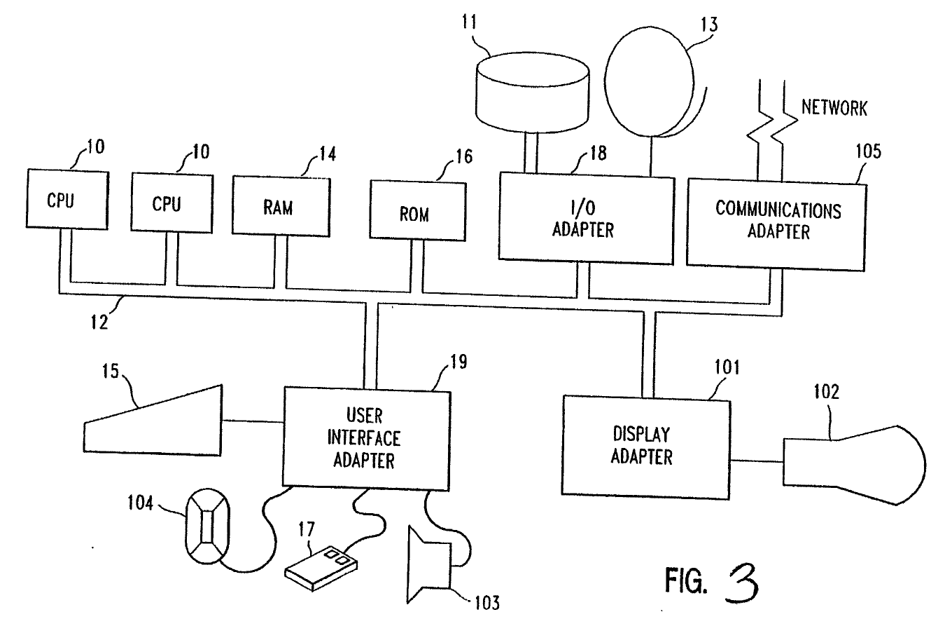

A representative hardware environment for practicing the present invention is depicted in FIG. 3, which illustrates a typical hardware configuration of an information handling/computer system in accordance with the subject invention, having at least one processor or central processing unit (CPU) 10. CPUs 10 are interconnected via system bus 12 to random access memory (RAM) 14, read-only memory (ROM) 16, an input/output (I/O) adapter 18 for connecting peripheral devices, such as disk units 11 and tape drives 13, to bus 12, user interface adapter 19 for connecting keyboard 15, mouse 17, speaker 103, microphone 104, and/or other user interface devices such as touch screen device (not shown) to bus 12, communication adapter 105 for connecting the information handling system to a data processing network, and display adapter 101 for connecting bus 12 to display device 102. A program storage device readable by the disk or tape units, is used to load the instructions which operate the invention which is also loaded onto the computer system.

With the invention, development teams are able to load to a common website within the installer for their application specific needs. The invention resolves the constant need to invent separate registration methodologies for each new application needed to be launched. The invention accommodates all operating systems and eliminates specialized work conventionally needed for deployment of each new application.

While the invention has been described in terms of preferred embodiments, those skilled in the art will recognize that the invention can be practiced with modification within the spirit and scope of the appended claims.

What is claimed is:

1. A system for transferring tools to resources, wherein said resources use said tools to accomplish tasks, said system comprising:
a public server connected to said resources;
a tool server connected to said public server; and
a database connected to said public server,
wherein said public server assigns said tasks to said resources based upon capabilities of said resources and provides said tools to said resources based upon profiles of said resources.

2. The system in claim 1, wherein said database maintains information regarding said profiles of said resources.

3. The system in claim 2, wherein said public server provides a version of said tool to said resource, based upon said profiles.

4. The system in claim 3, wherein said resources are provided an opportunity to verify and update said profiles and said capabilities as each task is assigned and said tool is provided.

5. The system in claim 1, wherein said database maintains information regarding said capabilities of said resources.

6. A system for transferring tools to resources, wherein said resources use said tools to accomplish tasks, said system comprising:
a public server connected to said resources;
a tool server connected to said public server; and
a database connected to said public server,
wherein said public server assigns said tools to said resources based upon profiles of said resources.

7. The system in claim 6, wherein said database maintains information regarding said profiles of said resources.

8. The system in claim 7, wherein said public server provides a version of said tool to said resource, based upon said profiles.

9. The system in claim 8, wherein said resources are provided an opportunity to verify and update said software and hardware profile and said task capabilities as each task is assigned and said tool is provided.

10. The system in claim 6, wherein said database maintains information regarding task capabilities of said resources.

11. The system in claim 10, wherein said public server assigns said tasks to said resources based upon said task capabilities of said resources.

12. A system for transferring tools to resources, wherein said resources use said tools to accomplish tasks, said system comprising:
a public server connected to said resources;
a tool server connected to said public server; and
a database connected to said public server, wherein:
said database maintains information regarding software and hardware profiles of each of said resources, and task capabilities of said resources,
said public server assigns said tasks to said resources based upon said task capabilities of said resources,
said public server provides a version of said tool to said resource, based upon said software and hardware profiles, and
wherein said resources are provided an opportunity to verify and update said software and hardware profiles and said task capabilities as each task is assigned and said tool is provided.

13. A method for transferring tools to resources, wherein said resources use said tools to accomplish tasks, said method comprising:
maintaining information regarding software and hardware profiles of said resources and task capabilities of said resources;
assigning said tasks to said resources using a public server based upon said task capabilities of said resources; and
providing, by said public server, a version of said tool to said resource, based upon said software and hardware profiles.

14. The method in claim 13, further comprising providing an opportunity to verify and update said software and hardware profiles and said task capabilities as each task is assigned and said tool is provided.

15. A method for transferring tools to resources, wherein said resources use said tools to accomplish tasks, said method comprising:
maintaining information regarding software and hardware profiles of said resources;
assigning said tasks to said resources using a public server; and
providing, by said public server, a version of said tool to said resources, based upon said software and hardware profiles.

16. The method in claim 15, further comprising maintaining task capabilities of said resources.

17. The method in claim 16, further comprising assigning said tasks to said resources using said public server based upon said task capabilities of said resources.

18. The method in claim 16, further comprising providing an opportunity to verify and update said software and hardware profiles and said task capabilities as each task is assigned and said tool is provided.

19. A method for transferring tools to resources, wherein said resources use said tools to accomplish tasks, said method comprising:
maintaining information regarding software and hardware profiles of each of said resources and task capabilities of said resources;
assigning said tasks to said resources using a public server based upon said task capabilities of said resources;
providing, by said public server, a version of said tool to said resource, based upon said software and hardware profiles; and
providing an opportunity to verify and update said software and hardware profiles and said task capabilities as each task is assigned and said tool is provided.

20. A program storage device readable by machine tangibly embodying a program of instructions executable by said machine for performing a method for transferring tools to resources, wherein said resources use said tools to accomplish tasks, said method comprising:
maintaining information regarding software and hardware profiles of said resources;
assigning said tasks to said resources using a public server; and
providing, by said public server, a version of said tool to said resource, based upon said software and hardware profiles.

21. The method in claim 20, further comprising maintaining task capabilities of said resources.

22. The method in claim 21, further comprising assigning said tasks to said resources using said public server based upon said task capabilities of said resources.

23. The method in claim 21, further comprising providing an opportunity to verify and update said software and hardware profiles and said task capabilities as each task is assigned and said tool is provided.
